(19) United States
(12) Patent Application Publication
(10) Pub. No.: US 2009/0254464 A1
(43) Pub. Date: Oct. 8, 2009

(54) TIME AND ATTENDANCE SYSTEM AND METHOD

(75) Inventors: Michael Davis Bonner, Port Huron, MI (US); Carl Edwin Albert, North Street, MI (US); William MIchael Hartman, Pleasant Ridge, MI (US)

Correspondence Address: DUANE MORRIS LLP - Philadelphia;IP DEPARTMENT, 30 SOUTH 17TH STREET, PHILADELPHIA, PA, 19103-4196, US

(73) Assignee: TIMETRAK SYSTEMS, INC., Port Huron, MI (US)

(21) Appl. No.: 12/061,352

(22) Filed: Apr. 2, 2008

(51) Int. Cl. G06Q 10/00

(52) U.S. Cl. 705/32

(57) ABSTRACT

A time and attendance system includes a biometric reader, a data collection terminal in communication with the biometric reader for collecting a biometric signature of a presented individual, a processor programmed to validate the collected biometric signature against one or more stored biometric signatures, and a camera for capturing an image of the presented individual. The image is included as part of a time and attendance transaction associated with the presented individual in response to a failed validation of the collected biometric signature.

### FIELD OF THE INVENTION

The present invention relates to time and attendance systems and methods.

### BACKGROUND OF THE INVENTION

Use of biometrics (e.g., fingerprint matching) has become increasingly popular in the time and attendance industry. Accurately recording time and attendance data for personnel can save a company time and money. The accuracy of the time and attendance data collection is based, in part, on personnel accurately identifying themselves to the data collection device and accurately entering time and attendance data. An intentional (i.e., buddy punching) or unintentional misidentification of oneself to a data collection device results in inaccurate data collection and thus inaccurate records, which are used to determine compensation, benefits and the like.

Biometric validation of an individual's identity relies on an enrollment process where a biometric signature is captured and stored for comparison during future validation attempts. Although a biometric signature is, in most cases, immutable and would never change (except in the case of injury), there is some level of tolerance built into biometric validation devices. This tolerance is provided to allow for the inherent differences, as subtle as they may be, between the stored enrollment biometric signature and the captured biometric signature being used for validation of the presented individual. If the tolerance of the biometric device is too high, false validations and identifications could result. If the tolerance of the biometric device is too low, slight variances to the biometric input method could result in a false failed validation.

In the event that an individual fails validation (i.e., the biometric signature cannot be matched to a pre-stored biometric signature), the transaction would either be accepted by the system and recorded, or rejected. In the case of the transaction being rejected, the individual may not be able to continue on with his task (e.g., beginning the work day) until the situation is corrected. In the case of the transaction being accepted and recorded, there is no method of ensuring that the individual that made the transaction is the individual that he identified himself to be.

### SUMMARY OF THE INVENTION

A time and attendance system includes a biometric reader, a data collection terminal in communication with the biometric reader for collecting a biometric signature of a presented individual, a processor programmed to validate the collected biometric signature against one or more stored biometric signatures, and a camera for capturing an image of the presented individual. The image is included as part of a time and attendance transaction associated with the presented individual in response to a failed validation of the collected biometric signature.

The above and other features of the present invention will be better understood from the following detailed description of the preferred embodiments of the invention that is provided in connection with the accompanying drawings.

### BRIEF DESCRIPTION OF THE DRAWINGS

The accompanying drawings illustrate preferred embodiments of the invention, as well as other information pertinent to the disclosure, in which:

FIG. 1 is a stylized system diagram of an embodiment of the time and attendance system of the present invention; and

FIG. 2 is a flow diagram illustrating the operation of an embodiment of the time and attendance system of the present invention.

### DETAILED DESCRIPTION

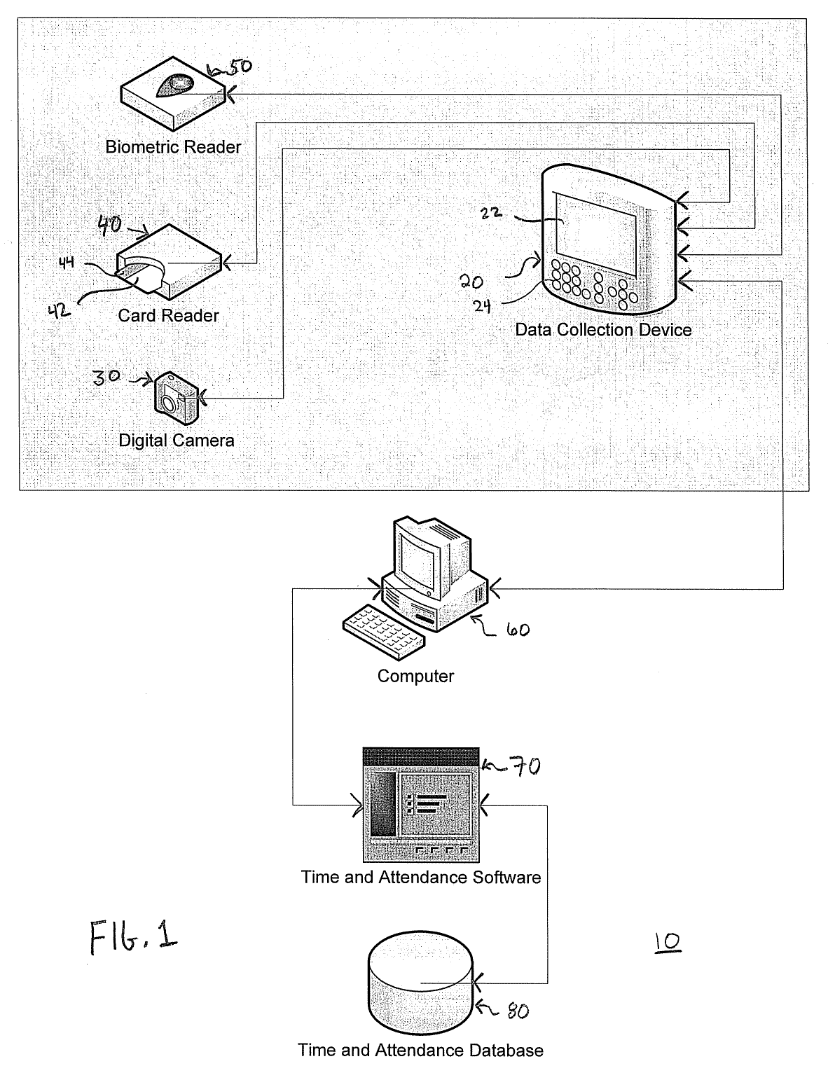

FIG. 1 is a stylized view of an embodiment of a time and attendance system 10. Although biometric validation allows for the ability to deny or reject a time and attendance transaction based on a failed biometric validation, which can lead to a high level of security and data accuracy, the ability to collect data and allow an individual to complete his task is of the utmost priority for the time and attendance industry. As described hereafter, capturing a digital image of the individual presented at the data collection device when biometric validation fails allows the individual to continue on with his task without first correcting the situation. Instead of denying the transaction, a record of the transaction is recorded including a digital image of the presented individual. The identity of the individual can be reviewed and visually validated at a later time using the digital image.

As used herein, “time and attendance transaction” is a record or communication containing data relevant to attendance (and time thereof) of an individual, such as an employee. Although not a requirement, typically, at a minimum, a time and attendance transaction includes data identifying an individual (or data sufficient to permit identification of the individual with some additional processing), and the time (e.g., time of day and date) that the individual presents himself for some task or duty to a data collection terminal.

Time and attendance system 10 includes a data collection front end that includes a data collection device or terminal 20, a biometric reader 50, a digital camera 30 and an optional card reader 40, each in communication with or integrated with the data collection device 20. The data collection device 20 includes a screen or monitor 22 and various buttons or other input means for receiving information or commands from a user.

As illustrated, the biometric reader 50 is a fingerprint reader, although other types of devices for collecting a biometric signature, such as an ocular pattern, thermal image, etc. may be used and the present invention is not limited by the type of biometric reader selected.

The card reader 40 is configured to receive a card 42, such as a card with a magnetic strip 44, for reading information stored thereon and communicate the information to the data collection device 20. In some embodiments, the card 42 has stored thereon information specific to a user that presents himself to the data collection device 20 for recording time and attendance information (i.e., clocking “in” or “out”). This information can include a unique identifier associated with the individual or other user specific identification information. Although shown as a card reader, other means for inputting user specific information can be employed, such as an RF ID device, a pin pad, a barcode reader, proximity reader for contactless smartcards, such as a MIFARE® reader, and the like.

Digital camera 30 is configured to capture digital images of a presented individual and communicate those images to the data collection device 20. Although illustrated as a digital camera, an analog camera may also be utilized in certain embodiments if desired. As used herein, “camera” refers to devices that can capture still images and/or video of a presented subject. Camera 30 may also be a web camera.

As shown in FIG. 1, the system 10 also includes a computer or other processor 60 in communication with the data collection device 20. The computer 60 is programmed with time and attendance software 70, which is used, for example, for recording, monitoring and analyzing time and attendance data for use in payroll and other business functions. Time and attendance data is stored in a time and attendance database 80. In operation, and as described in more detail below, the data collection device 20 communicates time and attendance transactions to the computer 60 for recordal in time and attendance database 80. Processor 60 can then use time and attendance software 70 to process the time and attendance data from time and attendance data 80 in various human resource tasks.

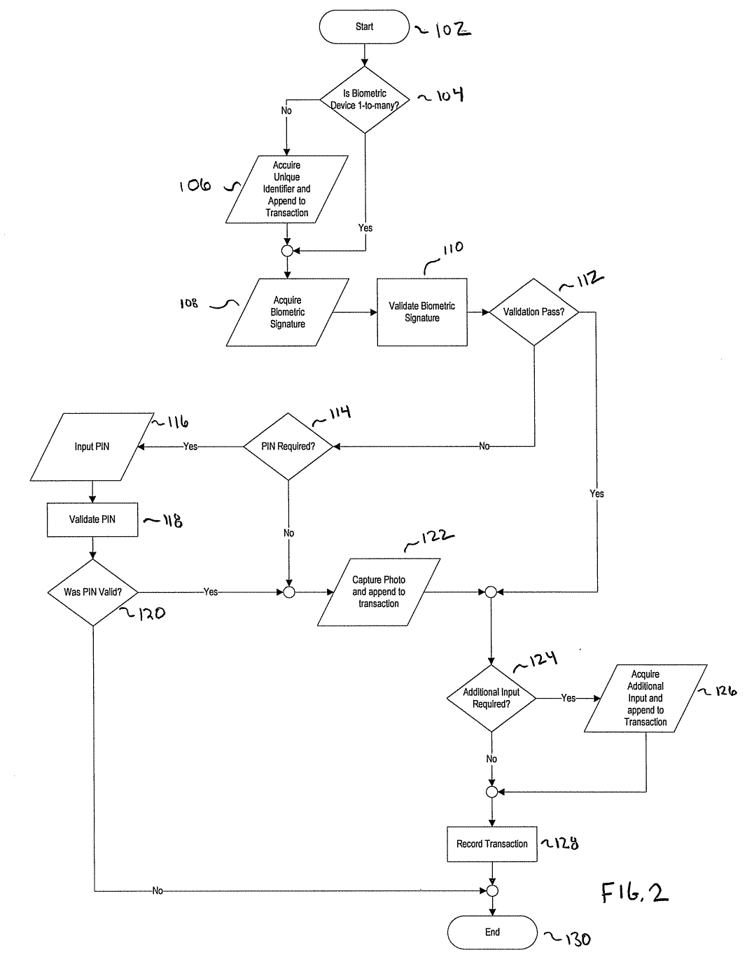

The operation of an embodiment of the system 10 is described below in connection with the flow diagram of FIG. 2. It should be understood that the operations shown in FIG. 2 can be implemented by programming the operating instructions of the processor of the data collection device 20, or, in the alternative, the data collection device can be a “dumb” terminal that operates under control of an external processor, such as computer 60 provided with appropriate software control, or a combination of the two (meaning, certain tasks are programmed into device 20 and certain task are controlled by computer 60). The person skilled in the art of programming and system design will understand that decisions on distribution of this functionality can be made based on system size, the need to be able to easily modify system functionality, hardware constraints, scalability needs, and the like.

At 102, the process begins. If the system is configured in a “1-to-many” mode (step 104), a biometric signature (e.g., fingerprint) is acquired using biometric reader 50 (step 108). In “1-to-many” mode, the system relies solely on a biometric validation process for validation and does not require the individual to enter or provide an assigned unique identifier. In this mode, the system compares a biometric signature against a database of biometric signatures without any foreknowledge of the identity of the individual that is presented. If the system is not operated in a “1-to-many” mode, the system has foreknowledge of the identify of the individual through the received unique identifier and can attempt validation by comparing the biometric signature against only those stored biometric signatures associated with that individual. This alternative is shown at step 106 where the system acquires a unique identifier from the individual, such as using card reader 40, and appends that unique identifier to the time and attendance transaction.

After acquiring the biometric signature at 108, the biometric signature is validated at 110. During validation, the acquired biometric signature is compared against one or more stored biometric signatures. In embodiments, the stored biometric signatures can be stored in memory of the data collection device 20, in a database associated with the data collection device 20, in the time and attendance database 80 or other location local to the data collection device 20 or remotely accessible. The comparison can be done by a processor within the data collection device 20 or by a computer/processor 60 in communication with the data collection device 20 or by a combination of the two devices, e.g., the computer could provide one or more stored biometric signatures to the data collection device 20 for comparison with the acquired biometric signature or vice versa. In any event, if the acquired biometric signature is validated (step 112), the process proceeds to step 124, where it is determined if additional input is required. Examples of additional input include, but are not limited to, department number, job number, etc. If additional input is required at step 124, the data collection device 20 acquires the additional input and appends it to the time and attendance transaction (step 126). At step 128, the time and attendance transaction, which includes information such as the acquired unique identifier, the time and date of the transaction and the identity of the individual, the result of the biometric validation, and additional inputted information from step 126, is recorded. The identity of the individual can be the unique identifier or, in the “1-to-many mode” be determined during the biometric signature validation process by determining the identity of the individual associated with the stored biometric signature that matches the acquired biometric signature. The transaction can be recorded in the data collection device 20 for later batch transfer with other transactions for storage in time and attendance database 80 or loaded to the time and attendance database 80 for storage on a transaction-by-transaction basis. The process ends at 130.

Returning to step 112, if the acquired biometric signature is not validated, i.e., there is no match between the collected biometric signature and a stored biometric signature, a determination is made as to whether a PIN (or other code or password known only to the presented individual) is required (step 114). If no PIN is required at 114, then a photo of the presented individual is captured with digital camera 30 and appended to the transaction. The process then proceeds to step 124 as described above.

If a PIN (or other identifier) is required at step 114, then the user is prompted to input a PIN, such as by a visual request on monitor 22. The user inputs the PIN at 116 and the system attempts to validate the PIN at 118 against a stored PIN associated with the received unique identification code of the presented individual. As with the acquired biometric signature, validation of the PIN can be performed by the data collection device 20 using a local database containing stored PINs or using data from a remote database, or by a backend processor, such as computer 60. If the PIN cannot be validated at 118, then at step 120 the process proceeds to the end (step 130) without recording the time and attendance transaction. If the PIN is validated, then the presented individual's image is captured at step 122 and included as part of the time and attendance transaction as described above and the process proceeds to step 124.

In an exemplary photo capture step 122, the system 10 operates to guide the presented individual into position for the photograph. For example, if a photograph of the individual is to be captured, the data collection device 10 can instruct the presented individual, such as by way of audio or visual command to position his face in front of camera 30. In one embodiment, a real time view from the camera is displayed on the monitor 22, thereby allowing the individual to see when he is properly aligned in front of the camera and make any necessary adjustments to the individual's position. Once the individual is properly aligned, the individual can trigger the camera 30 by depressing a button 24 or other input on the data collection device 20. Alternatively, the data collection device can include a timer that can trigger camera 30 to take a picture after expiration of a predetermined time period deemed sufficient for the user to properly align himself with the camera 30. Other alternatives include proximity sensors for triggering the camera, signal processing techniques for detecting and/or focusing on facial images, or the camera can be broadly focused to capture a large enough image area such that the desired image is likely captured.

Although the step of capturing of the photograph of the individual at step 122 has been described as being contingent on whether the biometric signature and the PIN have been validated at steps 110, 112, 118, 120, it should be understood that the system 10 can operate such that a photograph of the presented individual is taken each time that an individual uses the data collection device 10 to record time and attendance information. However, in this embodiment, appending the photograph to the time and attendance transaction is still contingent on whether the biometric signature and the PIN have been validated. In yet another alternative embodiment, in the event of a failed biometric signature validation, captured photographs and time and attendance transactions can be married in a record within the data collection device or at the back end of the system using some common identifier, such as a time stamp or other identifier.

As shown in FIG. 1, the biometric reader 50, card reader 40 and digital camera 30 are illustrated as being physically detached from the data collection device 20, this is merely for illustrative purposes and in certain contemplated embodiments, one or more of these device are integrated physically within the data collection device 20.

As discussed above, and by way of example only, the time and attendance transaction can include any of the following information: a time an date stamp; the individual's unique identifier; a PIN; an identity of the individual (as determined, for example, from a unique identifier, biometric signature or PIN comparison); the result of the biometric and/or PIN validations; additional system definable data inputted via the data collection device 20; and the captured digital image of the individual.

The ability to capture an image of the individual presented at the data collection device when biometric validation fails allows the individual to continue on with his task without first correcting the situation because additional proof of the individual's presence and identity can be recorded as part of the time and attendance transaction or event. A record of the transaction is recorded, and the identity of the individual can be reviewed and visually validated at a later time using the digital image.

Although the invention has been described in terms of exemplary embodiments, it is not limited thereto. Rather, the appended claims should be construed broadly to include other variants and embodiments of the invention that may be made by those skilled in the art without departing from the scope and range of equivalents of the invention.

What is claimed is:

1. A time and attendance system, comprising:
a biometric reader;
a data collection terminal in communication with said biometric reader for collecting a biometric signature of a presented individual;
a processor programmed to validate said collected biometric signature against one or more stored biometric signatures; and
a camera for capturing an image of said presented individual, wherein said image is included as part of a time and attendance transaction associated with said presented individual in response to a failed validation of said collected biometric signature.

2. The time and attendance system of claim 1, wherein said data collection terminal means for receiving a unique-identifier pre-assigned to said presented individual.

3. The time and attendance system of claim 1, wherein said data collection terminal comprises means for receiving a PIN from the presented individual in the event of the failed validation, the time and attendance system comprising means for validating said PIN, wherein said image is included as part of said transaction if said PIN is validated.

4. The time and attendance system of claim 1, wherein said data collection terminal includes a monitor for displaying a real-time image of said presented individual taken by said camera, thereby allowing said presented individual to align himself with the camera for image capture, and means for triggering capture of a still image of said presented individual for said time and attendance transaction.

5. The time and attendance system of claim 4, wherein said triggering means is user actuated or timer activated.

6. The time and attendance system of claim 1, further comprising a processor programmed with time and attendance software having access to said transaction for time and attendance data processing.

7. The time and attendance system of claim 1, wherein said camera is actuated to capture said image only if the validation of said collected biometric signature fails.

8. A method of operating a time and attendance system, comprising:
collecting a biometric signature of a presented individual;
validating said collected biometric signature against one or more stored biometric signatures;
capturing an image of said presented individual; and
providing said captured image as part of a time and attendance transaction associated with said presented individual in response to a failed validation of said collected biometric signature.

9. The method of claim 8, wherein said image is captured using a camera, wherein said camera is actuated to capture said image only if the validation of said collected biometric signature fails.

10. The method of claim 8, further comprising the steps of:
in the event of a failed validation, receiving a PIN from said presented individual;
validating the received PIN; and
providing said captured image as part of said transaction only if the PIN is validated.

11. The method of claim 8, further comprising the steps of receiving a unique identifier associated with said presented individual and recording said unique identifier as part of said transaction.

12. A time and attendance data collection terminal, comprising:
means for collecting a biometric signature of a presented individual; and
a camera for capturing an image of said presented individual, wherein said image is provided as part of a time and attendance transaction associated with said presented individual in response to a failed validation of said collected biometric signature.

13. The time and attendance data collection terminal of claim 12, wherein said means for collecting a biometric signature includes a biometric reader.

14. The time and attendance data collection terminal of claim 12, wherein said camera is a digital camera.

15. The time and attendance data collection terminal of claim 12, further comprising validation means for validating said collected biometric signature against one or more stored biometric signatures.

16. The time and attendance data collection terminal of claim 12, further comprising means for including said captured image as part of said time and attendance transaction and forwarding said transaction to a device remote from said time and attendance data collection terminal for recordation in a time and attendance database.

17. The time and attendance data collection terminal of claim 12, further comprising means for receiving a unique-identifier assigned to said presented individual.

18. The time and attendance data collection terminal of claim 12, further comprising means for receiving a PIN from the presented individual in the event of a failed validation, and providing said image as part of said transaction only if said PIN is validated.

19. The time and attendance data collection terminal of claim 12, further comprising a screen for displaying a real-time image of said presented individual taken by said camera, thereby allowing said presented individual to align himself with the camera for image capture, and means for triggering capture of a still image of said presented individual for provision as part of said transaction.

20. The time and attendance system of claim 12, further comprising means for actuating said camera to capture said image only if the validation of said collected biometric signature fails.
